(19) United States
(12) Patent Application Publication
(10) Pub. No.: US 2016/0018278 A1
(43) Pub. Date: Jan. 21, 2016

(54) IMPACT DETECTION

(71) Applicant: Perry Jeter, II, New Albany, OH (US)

(72) Inventor: Perry Jeter, II, New Albany, OH (US)

(21) Appl. No.: 14/804,051

(22) Filed: Jul. 20, 2015

Related U.S. Application Data
(60) Provisional application No. 62/026,267, filed on Jul. 18, 2014.

(51) Int. Cl. G01L 5/00

(52) U.S. Cl. CPC G01L 5/0052

(57) ABSTRACT

One or more embodiments of techniques or systems for impact detection are provided herein. In one or more embodiments, one or more sensors or sensor components may be embedded in an impact strip, helmet, article of clothing, apparel, accessories, etc. A sensor component may measure or take readings such as proper acceleration. These readings may be used to calculate velocities, force of a blow, speed of impact, etc. and notifications may be provided to appropriate parties when a force is determined to place a player or athlete at risk of injury. A database may be built from readings or measurements to determine different thresholds for different players (e.g., based on age, height, weight, etc.). In this manner, impact detection is provided.

### CROSS REFERENCE TO RELATED APPLICATIONS

This application claims the benefit of U.S. Provisional Application Ser. No. 62/026,267, filed Jul. 18, 2014, and entitled “INJURY MITIGATION,” the entirety of which is expressly incorporated herein by reference.

### BACKGROUND

Generally, protective head gear may be used in a variety of sports to protect against head related injuries caused by impact forces, including micro-traumatic brain injuries, received during use or play. Sports related head injuries are a growing problem in organized sports, such as football, for example. Even with mandatory use of helmets, head injuries occur in increasing numbers in frequency. Research has indicated that not only a single high energy impact to the head may be responsible for a players brain concussion, but also the repetitive accumulative damage that the player receives by multiple head impacts over time, also known as micro-traumatic brain injuries. A number of factors influence the increased rates of head impacts during play, such as the evolution of the style of tackling, running, or blocking. Modern play style leads to higher head injury rates wherein players suffer more multiple mild to severe concussions in the course of play than in the past.

Accordingly, by participating or playing sports, athletes have inherent risk for sustaining concussions. Research examining the long-term consequences of sport-related concussion has been inconsistent in demonstrating lingering neurocognitive decrements that may be associated with a previous history of concussion.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

One or more embodiments of techniques or systems for injury mitigation are provided herein. For example, impact strips, impact absorption strips, and/or deflection devices may be affixed to helmets or articles of clothing, such as jerseys, shoes, uniforms, etc. An impact absorption or deflection device may provide a flexible force transfer medium to absorb a blow of an impact. Enhanced performance criteria may be achieved by combining elastomeric synthetic resin compound materials of different performance properties forming inter-conforming matrix of energy absorbing air cells therewithin. Respective cells may afford interior configurations interlinked together with common walls for absorptive deflective properties.

In one or more embodiments, one or more of the impact strips, impact absorption strips, and/or other equipment may include one or more sensors embedded therein, such as an accelerometer, for example. Additionally, sensors or sensor components may be embedded in articles of clothing, helmets, boots, apparel, jerseys, shoes, foot ware, shoestrings, etc. The sensors may record or measure data associated with blows or hits an athlete (or another person) receives and transmit or communicate respective data to a party (or the party's respective device) who can utilize respective measurements to make real time decisions pertaining to the health or safety of the athlete.

The following description and annexed drawings set forth certain illustrative aspects and implementations. These are indicative of but a few of the various ways in which one or more aspects may be employed. Other aspects, advantages, or novel features of the disclosure will become apparent from the following detailed description when considered in conjunction with the annexed drawings.

### BRIEF DESCRIPTION OF THE DRAWINGS

Aspects of the disclosure are understood from the following detailed description when read with the accompanying drawings. Elements, structures, etc. of the drawings may not necessarily be drawn to scale. Accordingly, the dimensions of the same may be arbitrarily increased or reduced for clarity of discussion, for example.

FIG. 1 is a side elevational view of an example enhanced impact absorption strip, according to one or more embodiments.

FIG. 2 is a bottom plan view thereof, according to one or more embodiments.

FIG. 3 is a top plan view of enhanced impact absorption strip for protective head gear, according to one or more embodiments.

FIG. 4 is an exploded view of the impact absorption strip prior to assembly, according to one or more embodiments.

FIG. 5 is an enlarged end view thereof, according to one or more embodiments.

FIG. 6 is an enlarged graphic view of the interior honeycombed walled energy absorption deflective pattern defining air cells within the strip, according to one or more embodiments.

FIG. 7 is a front elevational view of a sports helmet representation with the impact absorption strips attached thereto in pattern orientation, according to one or more embodiments.

FIG. 8 is a rear elevational view thereof illustrating a placement example of the absorption strips, according to one or more embodiments.

FIG. 9 is an illustration of an example component diagram of a system for mitigating injuries, according to one or more embodiments.

FIG. 10 is an illustration of an example cross-sectional view of a helmet for mitigating injuries, according to one or more embodiments.

FIG. 11 is an illustration of an example flow diagram of a method for mitigating injuries, according to one or more embodiments.

FIG. 12 is an illustration of an example computer-readable medium or computer-readable device including processor-executable instructions configured to embody one or more of the provisions set forth herein, according to one or more embodiments.

FIG. 13 is an illustration of an example computing environment where one or more of the provisions set forth herein are implemented, according to one or more embodiments.

### DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art.

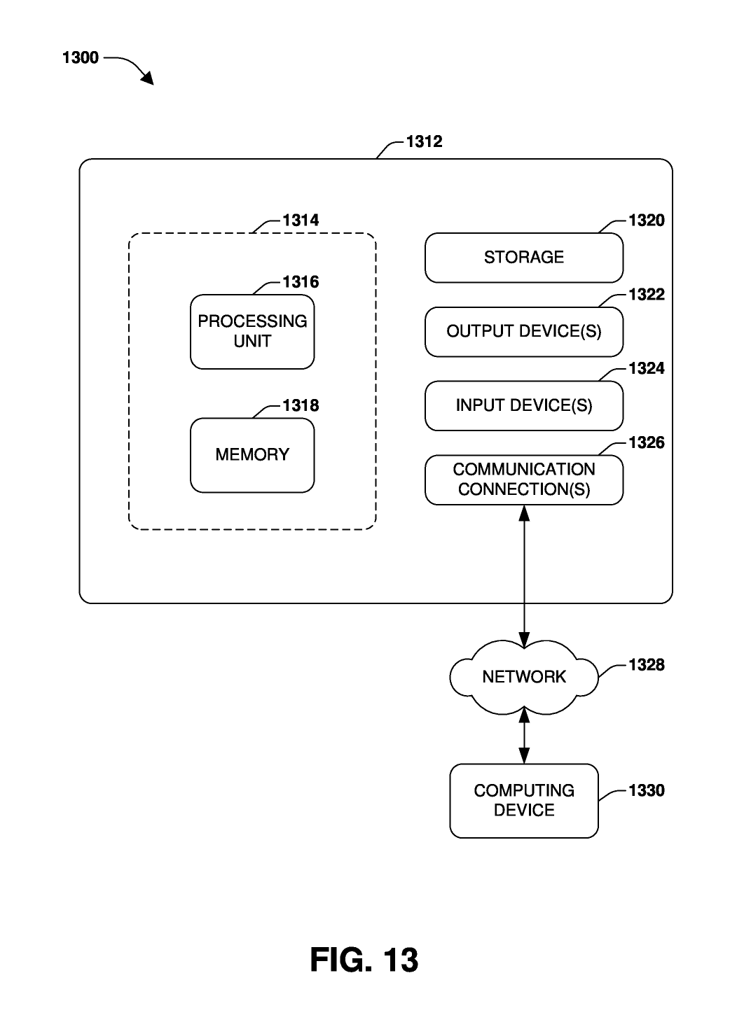

For one or more of the figures herein, one or more boundaries, such as boundary 1314 of FIG. 13, for example, may be drawn with different heights, widths, perimeters, aspect ratios, shapes, etc. relative to one another merely for illustrative purposes, and are not necessarily drawn to scale. For example, because dashed or dotted lines may be used to represent different boundaries, if the dashed and dotted lines were drawn on top of one another they would not be distinguishable in the figures, and thus may be drawn with different dimensions or slightly apart from one another, in one or more of the figures, so that they are distinguishable from one another. As another example, where a boundary is associated with an irregular shape, the boundary, such as a box drawn with a dashed line, dotted lined, etc., does not necessarily encompass an entire component in one or more instances. Conversely, a drawn box does not necessarily encompass merely an associated component, in one or more instances, but may encompass a portion of one or more other components as well.

The following terms are used throughout the disclosure, the definitions of which are provided herein to assist in understanding one or more aspects of the disclosure.

As used herein, the term “infer” or “inference” generally refer to the process of reasoning about or inferring states of a system, a component, an environment, a user from one or more observations captured via events or data, etc. Inference may be employed to identify a context or an action or may be employed to generate a probability distribution over states, for example. An inference may be probabilistic. For example, computation of a probability distribution over states of interest based on a consideration of data or events. Inference may also refer to techniques employed for composing higher-level events from a set of events or data. Such inference may result in the construction of new events or new actions from a set of observed events or stored event data, whether or not the events are correlated in close temporal proximity, and whether the events and data come from one or several event and data sources.

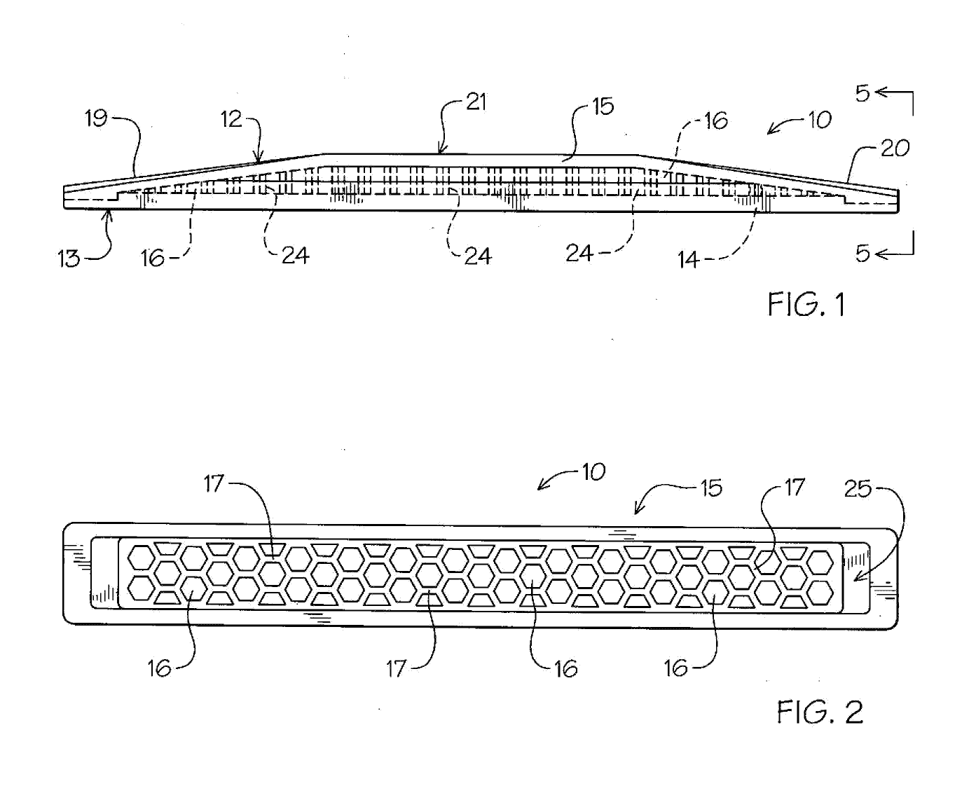

An example impact absorption strip and deflection device 10 is illustrated in FIG. 1-FIG. 4 of the drawings, in the form chosen for illustration, an elongated generally rectangular body member 11 with a contoured top surface 12 and oppositely disposed parallel flat textured material attachment bottom surface 13. While specific configurations and dimensions are shown and described, it is to be understood that alternative embodiments can include variations that are to be included within the scope of this disclosure and claims appended hereto. These alternative embodiments are consistent with, and included within, the spirit and/or scope of the innovation described herein.

A support base insert closure portion 14 and an upper impact engagement portion 15 are bonded permanently together to form an integrated composite performance structure. In yet other aspects, the bond is separable.

In the aspect illustrated, the upper engagement portion 15 has a plurality of hexagonal shaped recesses 16 therewithin defined by a matrix of corresponding interconnected hexahedral defined walls 17 referred to generally as a honeycomb configuration in which shared walls define an A-typical honeycomb pattern and the hexagonal recesses 16 therebetween defining independent air cells 16A. While hexagonal shaped walls and recesses are described, alternate shapes can be employed and are to be included within the spirit and/or scope of the specification and claims described herein.

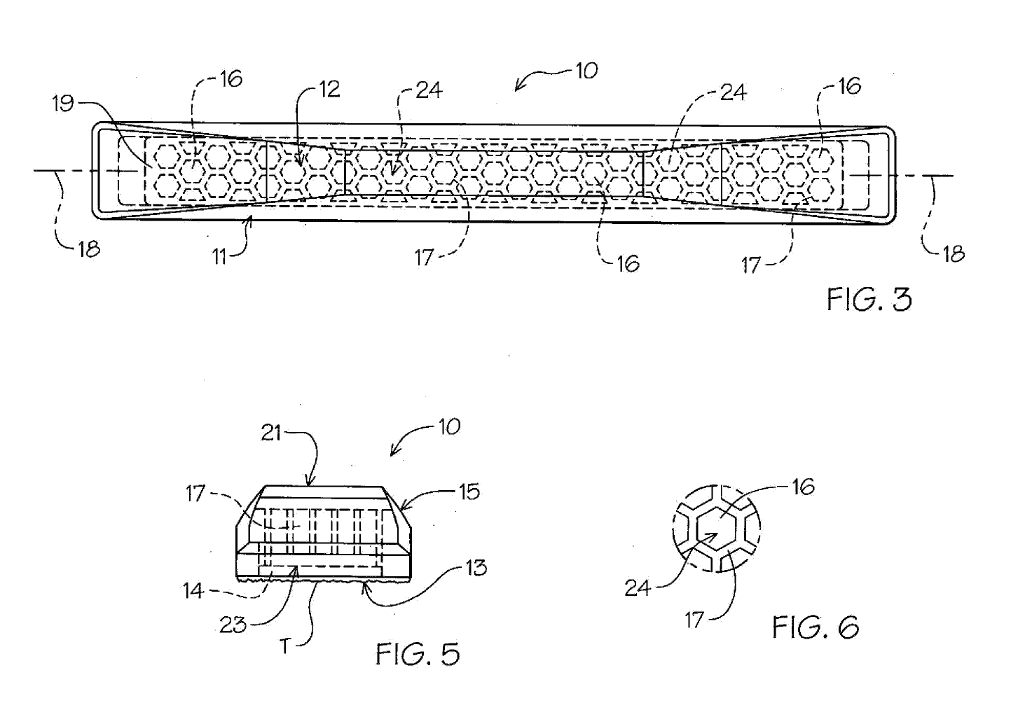

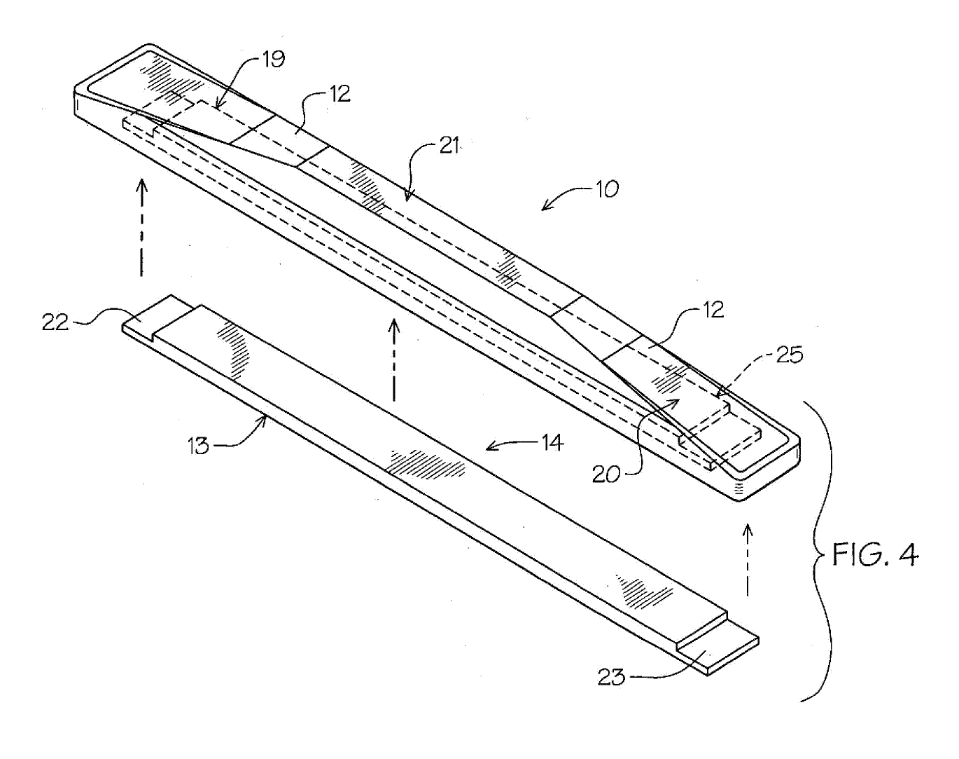

The example walls 17 and so defined hexagonal shaped recesses 16 are illustrated in FIG. 3 and FIG. 6 of the drawings in enlarged detail. In this example, the formed honeycomb wall pattern is oriented to begin centrally, midway along the longitudinal axis 18 within of the upper portion 15 as being offset translaterally to accommodate the end contours 19 and 20 of the top surface 12 as illustrated in FIG. 4 of the drawings.

The end contours 19 and 20 are tapered and therefor can provide for directional exterior impact occurring during use as will be described in greater detail hereinafter.

As so illustrated, the walls 17 and inter-defined recesses 16 extend beyond an overlying top planar surface 21 of the contoured top surface 12 and will therefore be enclosed within the engagement portion 15 by the base portion 14, as illustrated in FIG. 1 and FIG. 5 of the drawings. The base portion 14 is of a rectangular configuration having the flat textured attachment bottom surface 13 which is micro textured T to enhanced adhesive application and performance. The base portion 14 has oppositely disposed recessed end tabs 22 and 23 of a dimension and mating character for aligning and receiving in registration with a corresponding recessed bottom surface 25 of the top portion 15 as illustrated in FIG. 2 and FIG. 4 of the drawings.

Correspondingly, a plurality of hexagonal shaped sealed air cells 24 are formed therewithin once the upper engaged portion 15 and the support base portion 14 are bonded together along their abutting co-planar surfaces as will be well understood by those skilled in the art. It will be evident that while thermal bonding may be utilized for joining materials of this nature, other bonding techniques may be used to achieve the integrated engagement of the surfaces and to afford the sealing nature to define the corresponding cells 24.

The strip 10 may be formed of molded synthetic resin material, such as polymer (e.g. the visco-elastic polymer known in the trade as Akton® a registered trademark of Action Products, Inc., of Hagerstown, Md.), having varied elastomeric properties.

It will be apparent to those skilled in the art that while the honeycomb defined hexagonal walled 17, sealed air cells 24 configuration are of an efficient structural nature in this application, other cell wall patterns and shapes could be substituted.

Additionally, in some applications the honeycomb pattern or variance thereof could be eliminated wherein the upper portion 15 and bonded support base portion 14 may define an inner chamber in place of the cells 24 that may contain liquid, semi-liquid (e.g. gel material) or even a gaseous envelope or medium, in accordance with various embodiments.

The impact absorption strips 10 for protective head gear (and other appropriate implementations) may also be formed of a monolithic construction imparted by material choice and advanced resin molding methods to afford similar performance characteristics and therefore such constraints will not limit the scope of the disclosure.

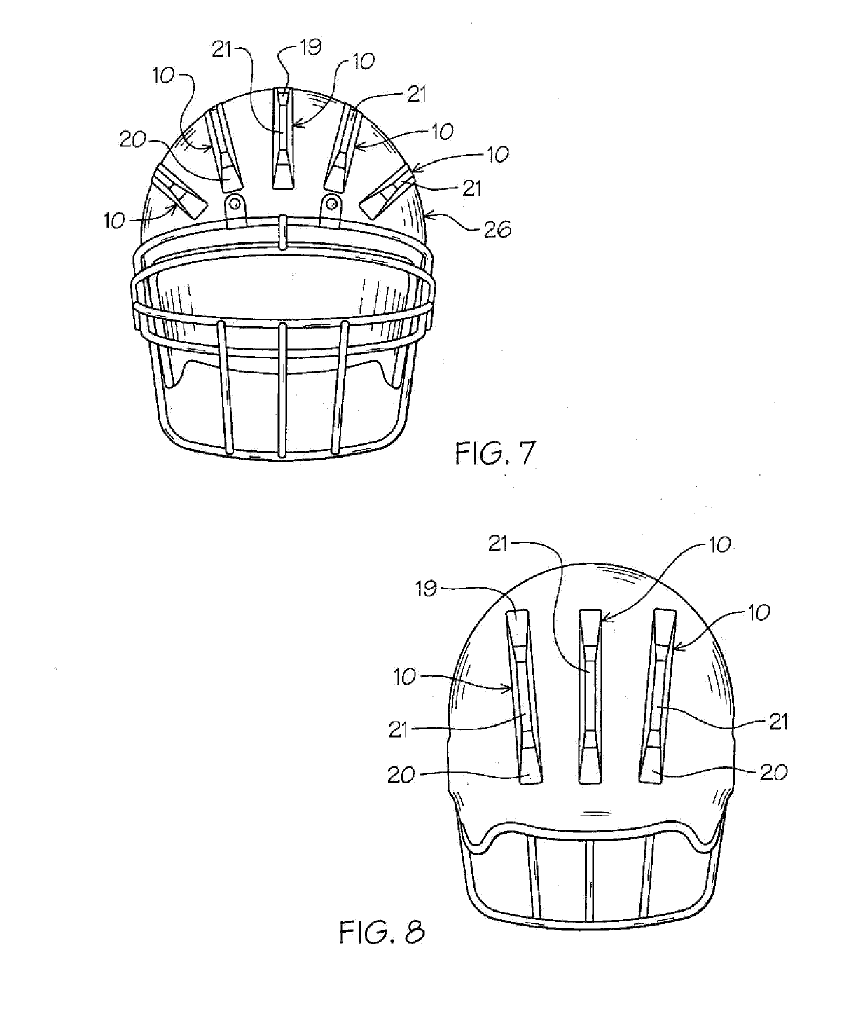

In the example, the upper impact engagement portion 15, as noted, is of an elastomeric polyurethane resin that may have a softer durometer than that chosen for the support base portion 14. The upper portion 15 (by having a “softer” elastomeric material to quickly absorb and then deflect impact energy) and the base support portion 14 (by having a harder durometer material for increased tensile strength) combine together to optimally allow for required application deflection while conforming to the contours and maintaining adhesion to a sport helmet 26 to which it is applied as illustrated graphically in FIG. 7 and FIG. 8 of the drawings. It will be appreciated that FIG. 7 and FIG. 8 are merely examples of impact absorption strips 10 and respective strips may be formed to have different thicknesses, widths, heights, lengths, shapes, etc. Further, different configurations of multiple strips may be implemented. For example, spacing between strips may be adjusted, the number of strips per helmet or surface, angle of strips relative to neighboring strips, etc. may be changed.

The universal utility imparted by the materials and design choices of the impact absorption strips 10 for protective head gear allows for a variety of mounting pattern placements on the helmet 26 generally illustrated in FIGS. 7 and FIG. 8 of the drawings. Such attachment is achieved by any one of a number of commercially available adhesives applied to the attachment bottom textured surface 13 of the strips 10.

The illustrated placement pattern of the strips 10 imparts their versatility having the contoured top surface 12 defined by the respective tapered end surfaces 19 and 20 and a flat top area 12A of reduced transverse dimension as illustrated in FIG. 1 of the drawings. These structural configurations may help to maintain the attachment of the strips 10 under the high kinetic energy impact field imparted during sports play contact.

While one or more embodiments include use of elastomeric polyurethane materials which may be transparent in nature, a number of opaque colorized resins may be used depending on user venue and desired aesthetic effect requested.

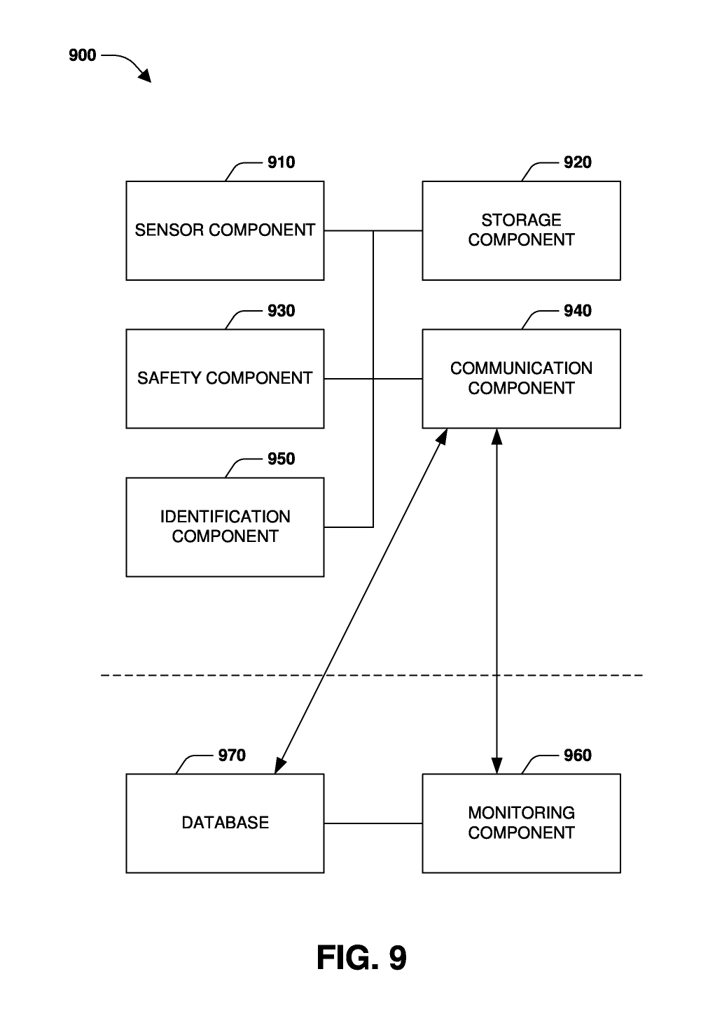

FIG. 9 is an illustration of an example component diagram of a system 900 for mitigating injuries, according to one or more embodiments. The system 900 may include one or more impact absorption strips, such as the impact absorption strips 10 as described in FIG. 1 through FIG. 8. In one or more embodiments, the system 900 may be embedded on an impact absorption strip, an impact strip, a helmet, a football helmet, an add-on, and so on, which may be affixed or attached to a helmet, etc. In other words, one embodiment provides for a system 900 which is attached to existing helmets which another embodiment provides for a helmet where technology such as the sensor component 910 or one or more other components may be built directly into or integrated with the helmet (e.g., during the molding process). As discussed, the system 900 may be implemented in a variety of ways, such as in add-on form attachable to helmets, wristbands, ankle bands, chest bands, elbow pads, knee pads, knee braces, shoulder pad, etc. Due to the modular nature of add-ons, different add-ons would be replaceable when damaged. Further, athletes or others would be able to utilize additional add-ons or systems 900 to collect additional data points, such as for different portions of their body or around different points on their helmets. In this way, the system 900 could be an external add-on to existing helmets, other articles of clothing, or equipment, thereby enabling players to obtain additional strips or systems 900 when a system becomes damaged, is knocked off, or is lost, for example.

The system 900 may take readings or include sensor technologies which record one or more usage characteristics, such as a force of a blow, a direction of a blow, time between hits or blows, average force of a blow, etc. These usage characteristics may be transmitted to a third party, who may monitor respective usage characteristics and take action accordingly, such as by calling paramedics, pulling a player from the field, etc. In other aspects, impact that exceeds a pre-defined or user-defined threshold can be captured.

Impact strips, such as impact strips 10 of one or more of the previous figures may deflect a blow or a force, minimize or mitigate force associated with a blow, or redirect force associated with a blow. In one or more embodiments, a sensor component 910 may include one or more components which may take readings, gather data, or measure a force of a blow, direction of a blow, etc. For example, the sensor component 910 may be an accelerometer, which may measure proper acceleration. As used herein, proper acceleration may be acceleration associated with the phenomenon of weight experienced by a test mass at rest in the frame of reference of the accelerometer or accelerometer device. In other words, proper acceleration is not necessarily acceleration as a rate of change of velocity (e.g., coordinate acceleration). Readings may include direction of a blow or speed of impact, for example.

For example, an accelerometer at rest on the surface of the earth will measure an acceleration g=9.81 m/s² straight upwards, due to the weight of the accelerometer. By contrast, accelerometers which are in free fall or at rest in outer space will measure zero. Another term for the type of acceleration that accelerometers can measure is g-force acceleration. As illustrated in FIG. 9, the sensor component 910 may be an accelerometer which measures g-force acceleration or proper acceleration. In aspects, an accelerometer may be a single-axis accelerometer or a multi-axis accelerometer.

Regardless, the sensor component 910 may detect magnitude and direction of the proper acceleration (e.g., g-force acceleration) as a vector quantity. Further, the sensor component 910 may sense an orientation of the accelerometer (or an orientation of an athlete, individual, equipment, helmet, etc. to which the accelerometer is affixed). The sensor component 910 may sense orientation based on direction of weight changes. Further, the sensor component 910 may measure coordinate acceleration (e.g., associated with a g-force or a change in a g-force), vibrations, shocks, movement, motion, such as falling in a resistive medium (when proper acceleration changes, since it starts at zero and increases), walking, running, dancing, force upon impact, collisions, concussions, explosions, etc. The sensor component 910 may include micro-machined accelerometers which may detect a position of a device or system 900.

The sensor component 910 may include a heart rate monitor, a breathing monitor, an activity tracker, a heart rate monitor, a breathing monitor, an image capture device, an infrared (IR) sensor, an ultrasound sensor, a pressure sensor, a blood pressure sensor, a sensor for blood glucose monitoring, a temperature sensor or a body temperature sensor, sensors for awareness, cardiac monitoring, health monitoring, neurological monitoring, respiratory monitoring, elapsed time, timers, etc. It will be appreciated that a sensor component 910, as used herein, may include one or more devices which measures a quantity and converts that quantity into a signal which may be read (e.g., such as by an observer or an electronic device or instrument). In this way, one or more of the sensor components 910 may receive one or more signals. Accordingly, when a player or individual is equipped or wearing a system 900 for injury mitigation and/or monitoring, which may be incorporated, integrated with, or woven into articles of clothing, for example, the sensor component 910 may collect or sense data or take measurements associated with a hit, a blow, a movement, a speed of a hit, a force associated with a blow, etc.

In one or more embodiments, the sensor component 910 may include a silicon micro-machine sensing element which enables peak performance in a low frequency range of operations. Further, the sensor component 910 may operate in a servo mode to achieve sustainability and linearity.

In one or more embodiments, the sensor component 910 may include one or more pairs of accelerometers which are extended over a region of space. These pairs of accelerometers may detect differences or gradients in proper accelerations for frames of references associated with those points. For example, if a player trips and falls, his or her feet may be associated with a first proper acceleration while his or her head may be associated with a second proper acceleration. In one or more embodiments, these devices or pairs may be gravity gradiometers, which may measure gradients in the gravitational field or gravitational waves. By measuring acceleration or proper acceleration associated with a hit, blow, or impact, a speed at which an impact may be determined. As an example, the safety component 930 may determine a speed of an impact based on a proper acceleration received by the sensor component 910.

The communication component 940 may utilize a wireless channel, a telematics channel, Bluetooth, or other channel to transmit data, measurements, calculations, identity data, etc. to a server or a monitoring component 960, a remote server (e.g., cloud based server or third party server), or database 970. The communication component 940 may also utilize wired connections, such as a USB connection to transmit data to another component. The database 970 or cloud server may be maintained between one or more entities or research departments and may be utilized for medical research or as a baseline for other warnings or notifications. In aspects, LoRa™ can employed by the communication component 940 to communicate and disseminate information throughout a desired network. As will be understood LoRa standardizes Low Power Wide Area Networks (LPWAN) being deployed around the world to enable Internet of Things (IoT), machine-to-machine (M2M), and smart city, and industrial applications.

In one or more embodiments, the storage component 920 may store measurements received by the sensor component 910, such as proper acceleration readings. Additionally, the storage component 920 may store calculations made by the safety component 930, such as a speed of impact, etc. Information stored, sensed, or calculated by respective components may be utilized in conjunction with external data, such as a medical determination, an age of a player, etc. to build a database 970 of injury mitigation data which may be utilized to alert players, coaches, etc. when an injury, such as a concussion may have occurred or if a risk of injury has increased, for example. As an example, the database 970 may include a minimum or threshold acceleration or proper acceleration vector associated with a head injury. In one or more embodiments, the database 970 may be shared between one or more organizations, such as a professional sports association or a collegiate sports association. In other embodiments, multiple organizations may provide data, such as from sensor components, safety components, or storage components of systems for injury mitigation to facilitate building of the injury mitigation database 970.

The identification component 950 may enable a player to provide identification for the system 900, such as name, player number, height, weight, age, etc. This information may impact or be used to determine thresholds for a player (e.g., an adult may be able to tolerate a higher force than a juvenile) or to associate that player with an application (e.g., so a parent may monitor his child) or to otherwise identify a player. In other words, because players may vary in age, weight, height, position, or other have other characteristics, different thresholds may be applied (pre-determined or user-defined) to different players or portions of their bodies. For example, a wristwatch of a coach may indicate that player number 82 should be pulled from the field of play for a medical examination after a hit.

In this way, the system 900 may be manufactured as biotech apparel which enables personnel, such as doctors, trainers, medical personnel, athletes, coaches, etc. to monitor one or more usage characteristics associated with the athlete, such as vital statistics, wear and tear, blood pressure, heart rate, etc. In one or more embodiments, the monitoring component 960 may be utilized to monitor one or more usage characteristics or health attributes measured by the sensor component 910, calculations made by the safety component 930, or data stored on the storage component 920. As an example, the monitoring component 960 may be a wristwatch or wearable device worn by a coach or other personnel which notifies (e.g., beeps, flashes, vibrates, etc.) and renders a uniform number or player name associated with an impact and impact data or force data associated with a hit. Because the system 900 or the sensor component 910 may take measurements when an impact or hit occurs, a frequency at which a player or subject is hit may be recorded. When a database 970 is built, individual player statistics may be compared against statistics of other players or an average, for example. These important statistics collected can be compared to other collisions of the data of comparable hit or impact frequency.

Using hockey as an example, problems with head injuries may often occur because players may be hitting the wall on a consistent basis. An accelerometer or sensor component 910 may be placed or fixed to a helmet, shoe, headband, mouth guard, or apparel to record or measure linear or rotational head movements. Here, the sensor component 910 may measure gravitational forces (e.g., g-forces) or radians per second squared for the rotational head movements, such as with a microchip. In this way, the sensor component 910 or system 900 may capture the frequency and location of impact. A communication component 940 may pass respective information along to a monitoring component 960, such as a wristwatch to be worn by a coach or other personnel. The monitoring component 960 may vibrate or provide one or more alerts when a hit exceeds a threshold force (pre-defined or user-defined), such as 20 g or 40 g of force. Accordingly, when the monitoring component 960 provides an alert, such as the vibration, audio, or other rendering, this may alert a trainer, physician, doctor, or parent to check on the subject or player in an immediate fashion or in real time. In one or more embodiments, an application or ‘app’ may be installed on a mobile device and a user may associate the application with a system 900 for injury mitigation (e.g., for a particular player, such as a son or daughter, etc.). The application may enable the user (e.g., the parent) to download the data, receive data or alerts in real time, etc., such as in a manner similar to operation of the wristwatch.

In one or more embodiments, the coach may wear the wrist watch or monitoring component 960 and when any one of his players wearing a system 900 for injury mitigation gets hit above a threshold force (e.g., different body parts may have different thresholds), the watch may beep or render other notifications to alert the coach that a player should be taken off the field for medical examination. Here, the monitoring component 960 may provide dynamic monitoring on a consistent or continually updated basis. In other embodiments, a helmet may be equipped with a safety component 930 which may render a notification directly for a player, such as an audio notification or a visual notification (e.g., by lighting an LED up on a helmet, etc.). The safety component 930 may determine one or more threshold force levels or other thresholds which when exceeded may generate one or more notifications which may alert a player or be transmitted via a communication component 940 to other parties (e.g., parents, coaches, etc.). In one or more embodiments, the safety component 930 may interact with a database 970 to determine threshold levels for a player. Further, context information, such as identity information, age, height, weight, medical history (e.g., player has had previous concussion within three months, etc.) may be utilized to set thresholds accordingly for the safety component 930. As discussed, if a threshold is exceeded, the safety component 930 may provide a notification or generate a response to be transmitted to a monitoring component 960, where the response may be indicative of a suggestion to further evaluate a player.

Regardless, the monitoring component 960 may provide feedback to one or more users, such as a team doctor, at substantially the same time as (e.g., in real time or near real-time) a player encounters a blow or an impact, thereby enabling personnel or staff to examine the player and determine whether or not that player should be removed from the game or other precautions may be taken.

It will be appreciated that one or more components of the system 900, such as the sensor component 910 may be integrated with (or otherwise into) apparel, equipment, clothing, helmets, etc. in a variety of ways. For example, a stud mounting device may be fixed to a helmet, shoe, apparel, or shoestring. The system 900 may be formed at least in part of Kevlar, Gortex, Gorilla Glass, etc. to deflect forces encountered or to mitigate most any water damage or sweat that may trigger an adverse effect. In the athletic shoes, accelerometers or the sensor component 910 may measure or calculate gait parameters, such as stance, swing phase for golf, baseball, hockey, etc. The sensor component 910 may determine speed, distance, mile times, etc. for runners.

The system 900 may provide a frequency response, which may be indicative of detected motions and report a true output. The frequency response may be measured in Hertz (Hz). A tri-axis may be utilized to detect inputs from most any place. The system 900 or device may have a housing which may be a rugged compact instrument for recording motion, shock, impact orientation and temperatures and which may feature real-time data streaming, a USB interface, and easy to use software. In one or more embodiments, LED lighting will be displayed to trigger as a backup to the vibrating watch (or other device) to trigger an alert. Regardless, the system 900 for injury mitigation may provide one or more notification to one or more parties, such as the player, coach, parents, etc. and may enable preventative or precautionary measures to be taken to mitigate effects of impacts in sports or other scenarios.

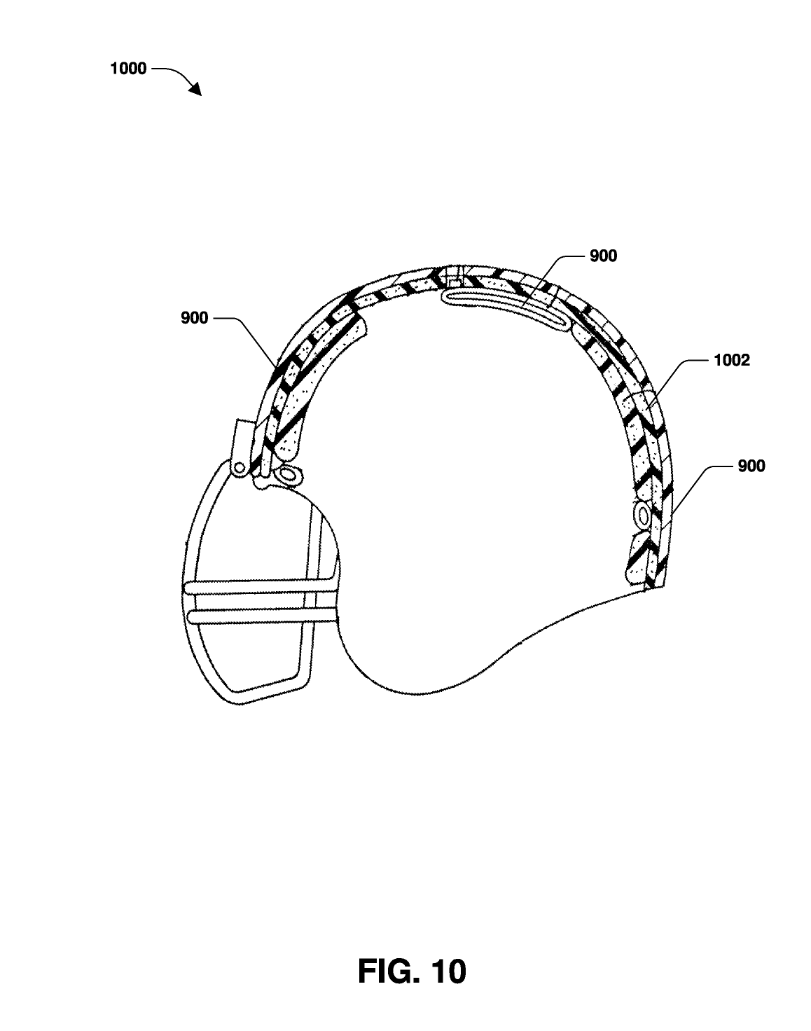

FIG. 10 is an illustration of an example cross-sectional view of a helmet 1000 for mitigating injuries or otherwise capturing data related to impact, according to one or more embodiments. According to one or more aspects, a helmet 1000 may be equipped with exterior helmet pads, such as enhanced impact absorption strips. In one or more embodiments, an entire or substantial portion of an outer surface of a helmet may be an impact absorption strip. As another example, an add-on or impact absorption strip may be applied to an outer surface of a helmet 1000. It will be appreciated that these exterior helmet pads or impact absorption strips may be affixed to (or otherwise incorporated into) different articles of clothing or equipment, such as protective headgear, helmets, jerseys, shoes, etc. Impact absorption strips may provide a layer of protection or reduce impact from blows associated with sports or other physical activity. The helmet 1000 may include padding 1002. For example, in a game of football, helmet to helmet contact may result in an impact force. Impact absorption strips may reduce such helmet to helmet impact. In FIG. 10, it can be seen that a helmet may be embedded with one or more systems 900 for injury mitigation.

As described in detail herein, it is to be understood that most any sensoring technology can be employed in accordance with the innovation. By way of example and not limitation, fabric sensors, silicone stretch sensors, dry electrodes, liquid crystals, etc. can be placed on a body. As the subject (e.g., athlete) moves, the sensor moves with them, changing its shape. Circuits can transmit information regarding how the sensors deform to a mclarle phase, tablet, wristwatch, etc. thereby providing real-time motion feedback. The data can then be transmitted to the cloud (e.g., bluemix technology) along with the long range LoRa based technology.

In addition to the embodiments described, soft capacitive sensors can be customized or integrated into compression garments for upper and lower limbs (and other body areas/surfaces) tracking performance to provide data to identify, address and/or correct the potential of injuries. It is to be understood that these sensors may enable the development of smarter technology in wearables, sports, healthcare combined by wearing embedded stretch sensors with accuracy sensors, circuit, software embedded into gloves for factory workers, gloves for athletes, gloves for military, gloves for firefighters, gloves for police, earplugs for airline workers on the ground to measure the G-forces or other potential injuries and has the ability to monitor remotely.

In furtherance of the above, it is to be understood that the technology described here, while described related to sports athletes, can be applied to most any environment whereby impact and/or injury (or potential risk of injury) can occur. These alternative environments and implementations are to be included within the spirit and/or scope of the innovation described herein.

Continuing with a discussion of stretch or flexible sensors, it will be understood that, in the example of an athlete's head/body motion, because the stretch sensors are wireless, soft and flexible enough to move naturally with the human body, the sensors stretch, changing capacitance value. These changes in values can be compensated for by integrated circuitry thereby maintaining an ability to accurately provide impact data, for example in real- or near real-time. In examples, each sensor can be monitored by an integrated circuit, which transmits stretch data to devices (e.g., M2M (Machine-to-Machine), bluetooth, LoRa enabled). Stretch, Pressure, Bend, Shear, custom sensors our technology in garments, clothing, gloves, wristwatch, wristband, hands or for ears stretch sensors are designed for measuring body motion to enable new methods of sports training.

In aspects, the motion to enable the smart shirts (e.g., sensor-equipped) are for active, impact-prone sports such as, hockey, football, track, hockey and for military, fire fighters, factory workers and provide precise data movement.

The innovation discloses an exciting new way for coaches, trainers, medical staff, doctors, etc. to provide feedback to athletes, military, EMS, fire fighters, factory workers, etc. The innovation also contemplates a mechanism to track posture during exercise, monitor rehabilitation of injuries which can be hosted by a cloud server, and long range ability, e.g., of over 3-5 miles up to 10 miles of coverage provided by LoRa.

In aspects, the sensors can be water resistant, e.g., used by way of casing sensors in the silicone which is suited for integration into medical devices, wearables, sensors and for soft industrial applications due to the ability to repel water. These sensors can be wiped down and sterilized, and can allow for direct skin to sensor coupling, e.g., medical-grade electrocadiogram, 2-axis acceleration, true respiration, body temperature, speed, distance, cadence, total steps, activity recognition & classification.

The sensors as described in the helmet examples can provide for GPS, acceleration, Impact Sensors, Location, Velocity, Angular Velocity, Linear Velocity, e.g., +/−25 cm), Time Stamp video for performance accuracy, Algorithm and code performance analytics on clients, parameters for movement, ECG/EKG, among others.

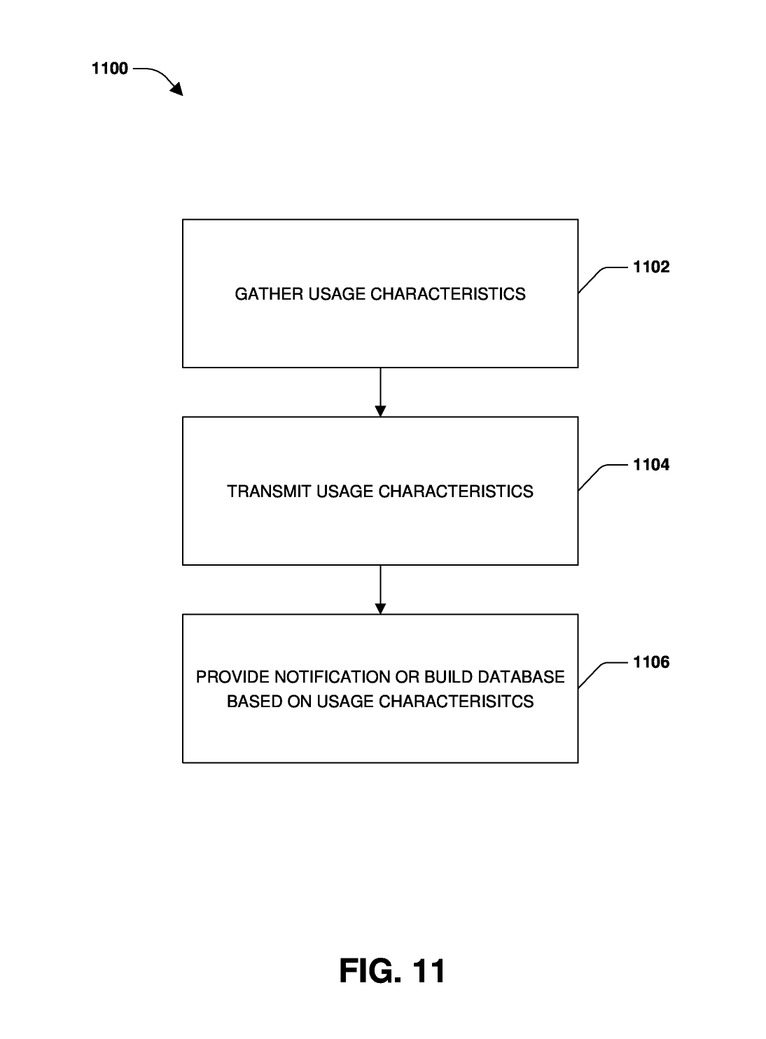

FIG. 11 is an illustration of an example flow diagram of a method 1100 for mitigating injuries, according to one or more embodiments. At 1102, one or more usage characteristics may be gathered, such as direction of blow, force of blow, etc. At 1104, one or more of the usage characteristics may be transmitted, such as to a monitoring component, for example. At 1106, a notification may be rendered or a database may be built based on respective usage characteristics.

One or more embodiments may employ various artificial intelligence (Al) based schemes for carrying out various aspects thereof. One or more aspects may be facilitated via an automatic classifier system or process. A classifier is a function that maps an input attribute vector, x=(x1, x2, x3, x4, xn), to a confidence that the input belongs to a class. In other words, f(x) =confidence (class). Such classification may employ a probabilistic or statistical-based analysis (e.g., factoring into the analysis utilities and costs) to prognose or infer an action that a user desires to be automatically performed.

A support vector machine (SVM) is an example of a classifier that may be employed. The SVM operates by finding a hypersurf ace in the space of possible inputs, which the hypersurface attempts to split the triggering criteria from the non-triggering events. Intuitively, this makes the classification correct for testing data that may be similar, but not necessarily identical to training data. Other directed and undirected model classification approaches (e.g., naïve Bayes, Bayesian networks, decision trees, neural networks, fuzzy logic models, and probabilistic classification models) providing different patterns of independence may be employed. Classification as used herein, may be inclusive of statistical regression utilized to develop models of priority.

One or more embodiments may employ classifiers that are explicitly trained (e.g., via a generic training data) as well as classifiers which are implicitly trained (e.g., via observing user behavior, receiving extrinsic information). For example, SVMs may be configured via a learning or training phase within a classifier constructor and feature selection module. Thus, a classifier may be used to automatically learn and perform a number of functions, including but not limited to determining according to a predetermined criteria.

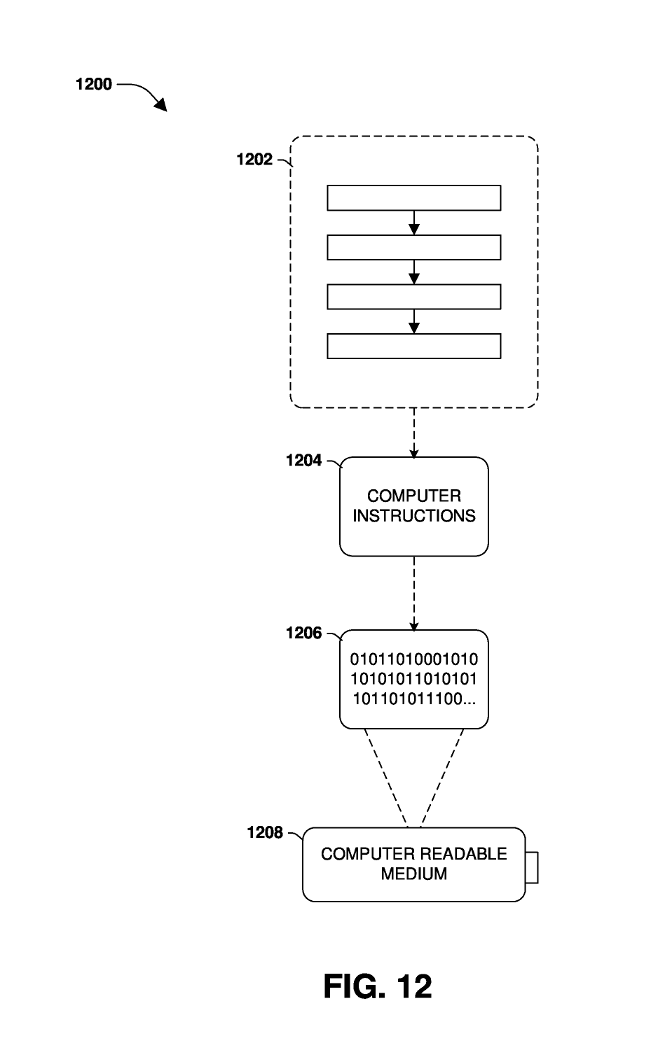

Still another embodiment involves a computer-readable medium including processor-executable instructions configured to implement one or more embodiments of the techniques presented herein. An embodiment of a computer-readable medium or a computer-readable device devised in these ways is illustrated in FIG. 12, wherein an implementation 1200 includes a computer-readable medium 1208, such as a CD-R, DVD-R, flash drive, a platter of a hard disk drive, etc., on which is encoded computer-readable data 1206. This computer-readable data 1206, such as binary data including a plurality of zero's and one's as shown in 1206, in turn includes a set of computer instructions 1204 configured to operate according to one or more of the principles set forth herein. In one such embodiment 1200, the processor-executable computer instructions 1204 may be configured to perform a method 1202, such as the method 1100 of FIG. 11. In another embodiment, the processor-executable instructions 1204 may be configured to implement a system, such as the system 900 of FIG. 9. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 13 and the following discussion provide a description of a suitable computing environment to implement embodiments of one or more of the provisions set forth herein. The operating environment of FIG. 13 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, embodiments are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 13 illustrates a system 1300 including a computing device 1312 configured to implement one or more embodiments provided herein. In one configuration, computing device 1312 includes at least one processing unit 1316 and memory 1318. Depending on the exact configuration and type of computing device, memory 1318 may be volatile, such as RAM, non-volatile, such as ROM, flash memory, etc., or a combination of the two. This configuration is illustrated in FIG. 13 by dashed line 1314.

In other embodiments, device 1312 includes additional features or functionality. For example, device 1312 may include additional storage such as removable storage or non-removable storage, including, but not limited to, magnetic storage, optical storage, etc. Such additional storage is illustrated in FIG. 13 by storage 1320. In one or more embodiments, computer readable instructions to implement one or more embodiments provided herein are in storage 1320. Storage 1320 may store other computer readable instructions to implement an operating system, an application program, etc. Computer readable instructions may be loaded in memory 1318 for execution by processing unit 1316, for example.

The term “computer readable media” as used herein includes computer storage media. Computer storage media includes volatile and nonvolatile, removable and non-removable media implemented in any method or technology for storage of information such as computer readable instructions or other data. Memory 1318 and storage 1320 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by device 1312. Any such computer storage media is part of device 1312.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 1312 includes input device(s) 1324 such as keyboard, mouse, pen, voice input device, touch input device, infrared cameras, video input devices, or any other input device. Output device(s) 1322 such as one or more displays, speakers, printers, or any other output device may be included with device 1312. Input device(s) 1324 and output device(s) 1322 may be connected to device 1312 via a wired connection, wireless connection, or any combination thereof. In one or more embodiments, an input device or an output device from another computing device may be used as input device(s) 1324 or output device(s) 1322 for computing device 1312. Device 1312 may include communication connection(s) 1326 to facilitate communications with one or more other devices.

Although the subject matter has been described in language specific to structural features or methodological acts, it is to be understood that the subject matter of the appended claims is not necessarily limited to the specific features or acts described above. Rather, the specific features and acts described above are disclosed as example embodiments.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A system for impact detection, comprising:
a sensor component taking one or more acceleration measurements related to an impact;
an identification component receiving one or more identifiers associated with a user equipped with the system for impact detection; and
a communication component transmitting one or more of the acceleration measurements received from the identification component.

2. The system of claim 1, further comprising a safety component that renders a notification related to the impact.

3. The system of claim 2, wherein the notification is a visual notification.

4. The system of claim 2, wherein the notification is an audible notification.

5. The system of claim 2, wherein the notification is a vibratory notification.

6. The system of claim 2, wherein the notification is received via a wearable device.

7. The system of claim 2, wherein the notification is rendered in accordance with exceeding an impact threshold.

8. The system of claim 7, wherein the impact threshold is user-defined.

9. The system of claim 8, wherein the impact threshold is a function of at least two of identity information, age, height, weight, and medical history.

10. The system of claim 1, wherein the sensor component is an impact strip attached to a helmet.

11. The system of claim 1, wherein the sensor component is embedded within an article of clothing.

12. The system of claim 1, wherein the sensor component is a flexible and expandable sensor component.

13. The system of claim 1, wherein the acceleration measurements employ calculation of velocities, force of a blow, or speed of impact.
